(19) United States
(12) Patent Application Publication
(10) Pub. No.: US 2013/0054533 A1
(43) Pub. Date: Feb. 28, 2013

(54) VERIFYING A DATA RECOVERY COMPONENT USING A MANAGED INTERFACE

(71) Applicants: Howard Hao, Bothell, WA (US); James Robert Benton, Seattle, WA (US); Thothathri Vanamamalai, Mill Creek, WA (US)

(72) Inventors: Howard Hao, Bothell, WA (US); James Robert Benton, Seattle, WA (US); Thothathri Vanamamalai, Mill Creek, WA (US)

(73) Assignee: MICROSOFT CORPORATION, Redmond, WA (US)

(21) Appl. No.: 13/216,960

(22) Filed: Aug. 24, 2011

(51) Int. Cl. G06F 7/00

(52) U.S. Cl. 707/649; 707/674; 707/E17.007; 707/E17.044

(57) ABSTRACT

The subject disclosure is directed towards verifying a data recovery component of a volume snapshot service using a managed interface. The managed interface enables interoperability between the data recovery component and one or more complementary data recovery components by converting compatible instructions for the data recovery component and a complementary data recovery component into native data recovery operations for the volume snapshot service and vice versa. Via the managed interface, the complementary data recovery component emulates the native data recovery operations. Using status information associated with such an emulation, the data recovery component is verifiable.

### BACKGROUND

Contemporary operating system based data recovery software applications are deployed at an enterprise-level as well as at a user-level. The current landscape includes a number of third-party vendors developing various components of the operating system-based data recovery software solutions, such as backup/restore applications (i.e., requestors), storage providers and application-specific writers. Many of the third-party vendors utilize a volume snapshot service (e.g., MICROSOFT Windows® operating system-based Volume Shadow Copy Service (VSS)) to retain point-in-time consistent data for data backup and/or restore processes.

Today, these third party vendors use a framework of application programming interfaces (APIs) associated with the volume snapshot service to develop these components. To facilitate a stable user experience, a third party vendor needs to develop a data recovery software component, such as a requestor, that is compatible with the framework of APIs and interoperable with complementary data recovery software components, such as a writer or a provider, from different vendors. Unfortunately, none of these third party vendors can develop and/or debug the requestors, the providers and/or the writers without considerable difficulty.

One of a number of reasons behind such difficulty is that the volume snapshot service framework is implemented using a lower-level programming platform. Similarly, developing an application-specific writer or a storage provider faces the same dependency challenges as developing backup/restore applications. Currently, native volume snapshot service interfaces are designed for volume snapshot service aware data recovery components. The interfaces utilized by these components are complex and extremely time consuming to implement. Verifying compatibility and/interoperability of any one of these components is a significant undertaking and is cumbersome for the software developers and quality assurance software engineers.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed to verifying a data recovery component of a volume snapshot service using a managed interface. In one aspect, an emulation module builds the managed interface using a wrapper that exposes native interface functions of the volume snapshot service to the data recovery component. Hence, instructions that are produced by the data recovery component are based on a higher level programming platform. Using the wrapper, the managed interface facilitates conversion between these instructions and native data recovery operations.

The managed interface includes one or more complementary data recovery components that are interoperable with the data recovery component. In another aspect, the one or more complementary data recovery components simulate execution of commands that are based on the native data recovery operations and issued by the volume snapshot service in order to verify compatibility of the data recovery component and/or validate any errors associated with the native data recovery operations.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary system for verifying a data recovery component using a managed interface according to one example implementation.

FIG. 2 is a block diagram illustrating an exemplary system for emulating native data recovery operations according to one example implementation.

FIG. 3 is a block diagram illustrating an exemplary framework for verifying a data recovery component according to one example implementation.

FIG. 4 is a flow diagram illustrating steps for verifying a data recovery component using a managed interface according to one example implementation.

FIG. 5 is a flow diagram illustrating steps for verifying a requestor using a managed interface according to one example implementation.

FIG. 6 is a flow diagram illustrating steps for verifying a writer using a managed interface according to one example implementation.

FIG. 7 is a flow diagram illustrating steps for verifying a provider using a managed interface according to one example implementation.

FIG. 8 is a block diagram representing exemplary non-limiting networked environments in which various embodiments described herein can be implemented.

FIG. 9 is a block diagram representing an exemplary non-limiting computing system or operating environment in which one or more aspects of various embodiments described herein can be implemented.

### DETAILED DESCRIPTION

Various aspects of the technology described herein are generally directed towards providing a managed interface to verify compliance between a data recovery component and a volume snapshot service that uses one or more complementary data recovery components. In addition, the managed interface enables interoperability between the data recovery component and the one or more complementary data recovery components. In one exemplary implementation, an emulation module provides the managed interface and the one or more complementary data recovery components for the purpose of emulating native data recovery operations that correspond with instructions in a higher level programming platform as described herein.

To effectuate compliance and interoperability, the managed interface converts instructions from the data recovery component into native data recovery operations that are executed by the volume snapshot service. In response, the volume snapshot service communicates native data recovery operations (e.g., events, notifications, function calls and/or the like) to the one or more complementary data recovery components via the managed interface. As described herein, the managed interface converts the native data recovery operations into compatible commands for the one or more complementary data recovery components, which simulates execution of these commands in order to perform the compliance and interoperability verification.

According to one exemplary implementation, the volume snapshot service is a set of Component Object Model (COM) and C++ application programming interfaces (APIs) that provides standardized interfaces, enabling third party backup and restoration application software to centrally manage backup processes and restore processes on a variety of application data and/or system data. In addition, the volume snapshot service also provides standardize interfaces for developing hardware providers or software providers as well as application-specific writers. The volume snapshot service also implements a framework that enables volume snapshots, backups and/or restorations to be performed while the application-specific writers continue to access to the volumes. When performing a backup, the volume snapshot service closely coordinates the snapshot creation process with the application-specific writers such that write-access permission to the volume is revoked for a minimal time period while read-access to the volume continues unabated.

In one exemplary implementation, the volume snapshot service application programming interfaces (APIs) are not accessible from the managed interface based in C# without a wrapper written in C++ and Common Language Infrastructure (CLI). The wrapper is exposed to the managed interface through COM and C++ interfaces. Writing a managed interface in C++/CLI enables using C# or Visual Basic to create and expose a volume snapshot to an application built in a higher-level programming platform (e.g., .NET) as described further below.

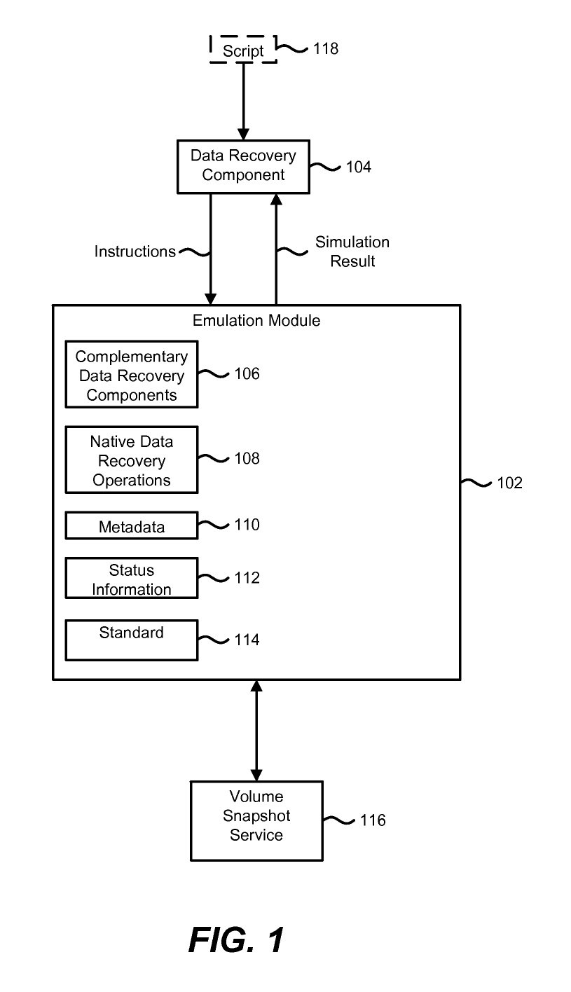

FIG. 1 is a block diagram illustrating an exemplary system for verifying a data recovery component using a managed interface according to one example implementation. The exemplary system may support data recovery mechanisms that are provided by different vendors. The exemplary system includes various example components, such as an emulation module 102 and a data recovery component 104 as described herein.

According to one exemplary implementation, the emulation module 102 provides the managed interface that confirms interoperability between a volume snapshot service 116 and the data recovery component 104. The emulation module 104 implements native interface functions in a higher level programming platform, which eliminates the requirement that the data recovery component 104 use the native interface functions to interact with one or more complementary data recovery components 106. Instead, the data recovery component 104 calls higher level implementations of the native interface functions using compatible instructions (i.e., executable software code), which convert these instructions into native data recovery operations 108.

Similarly, the one or more complementary data recovery components 106 also call various higher level implementations of the native interface functions using compatible instructions. The one or more complementary data recovery components 106 are used to evaluate compatibility of the data recovery component 104 with the volume snapshot service by simulating activities in response to the native data recovery operations 108. In one exemplary implementation, the one or more complementary data recovery components 106 generate various metadata 110, such as writer identification information, file and/or volume selections, file path information, restore method configuration, LUN information and/or parameters for directing volume snapshot creation by a provider. For example, the writer identification information may indicate which file types (e.g., a hypervisor virtual machine configuration file) are managed by a particular writer.

After the volume snapshot service 116 executes the native data recovery operations 108, the emulation module 102 produces status information 112 for the data recovery component 104 and the one or more complementary data recovery components 106. In one exemplary implementation, the status information 112 includes one or more return values or codes indicating a success or a failure with a volume snapshot creation process, a backup process or a restore process. The one or more complementary data recovery components 106 may return one or more errors explaining why the backup process or the restore process failed. The status information 112 may also include handled events and notifications. The status information 112 is compared with a standard 114 that defines guidelines ensuring compatibility between the one or more complementary data recovery components 106 and the data recovery component 104. The emulation module 102 produces a simulation result based on such a comparison.

The volume snapshot service 116 typically includes three components, such as a requestor (i.e., an application for requesting volume snapshot creation), a provider (i.e., a component that provides the functionality to actually make the volume snapshot) and a writer (i.e., application-specific software that acts to ensure that application data is ready for volume snapshot creation). The providers are also known as mass storage providers and implement hardware or software solutions to create volume snapshots. Applications, such as MICROSOFT SQL server, MICROSOFT Exchange server, and/or the like, provide their own volume snapshot service aware writers to provide metadata for coordinating the backup or restore of their application data.

The volume snapshot service 116 coordinates these components for the purpose of creating volume snapshots or performing a backup or restoration. The requestor initiates the volume snapshot creation, backup and/or restore processes and the provider controls execution of these processes across a storage system. For example, the requestor instructs the writer to prepare a dataset for a backup process. When the dataset is ready, the requestor then instructs the provider to create the volume snapshot, which holds an application-consistent copy of the dataset. During a restore process, the requester restores the dataset to its original or alternate location using requester supplied backup media under full visibility and coordination with the application-specific writer.

In one exemplary implementation, the emulation module 102 may use the standard 114 to determine whether writer metadata or requestor metadata complies with the volume snapshot service 116. The emulation module 102 may use the standard 114 to determine whether certain available resources meet the volume snapshot service 116 requirements. Furthermore, the emulation module 102 may induce faults by removing a resource for which the data recovery component 104 indicates a failure with a standard error code. In another exemplary, the standard 114 may indicate that a volume snapshot can be only taken on supporting LUNs. The emulation module 102 may report LUN information indicating a lack of supporting LUNS to which the data recovery component responds with an appropriate error code.

Optionally, a script 118 may be executed to determine which instructions are communicated from the data recovery component 104 and the one or more complementary data recovery components 106. The script 118 may be employed as an alternative to using command line parameters to generate these instructions.

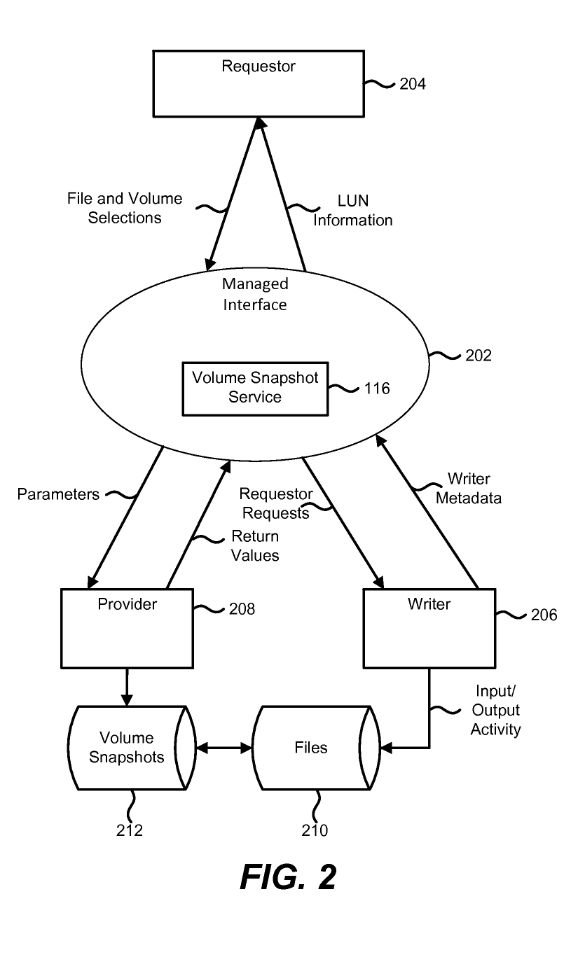

FIG. 2 is a block diagram illustrating an exemplary system for emulating native data recovery operations according to one example implementation. The exemplary system includes a managed interface 202 for verifying interoperability between various data recovery components, such as a requestor 204, a writer 206 and a provider 208. Furthermore, the managed interface 202 also verifies compliances with the volume snapshot service 116. The requestor 204 may emulate a known, commercial requestor, such as a data backup application or a data restore application. In another exemplary implementation, the requestor 204 may be new data backup or restore application whose compatibility with the writer 206 and the provider 208 requires verification.

Similarly, the writer 206 may emulate a known, commercial writer for a certain type of application, such as an email application, a word processing application, a database application, a virtual machine management application (e.g., Hyper-V application) and/or the like. The writer 206 may store files 210 on a storage system. Each of the files 210 may represent one or more volumes. In another exemplary implementation, the writer 206 may be new writer application whose compatibility with the requestor 204 and the provider 208 requires verification. Furthermore, the writer 206 performs various input/output (I/O) activity on the files 210 and updates various volume and file metadata, such as file locations and path information.

Furthermore, the provider 208 may emulate a known, commercial hardware or software provider, such as a system provider or data provider. In another exemplary implementation, the provider 208 may be new software or hardware provider (e.g., a hardware or software provider) whose compatibility with the writer 206 and the requestor 204 requires verification.

The requestors 204, the provider 208 and the writer 206 communicate, via the managed interface 202 for the volume snapshot service 116, in order to coordinate creation of volume snapshots 212 as well as performance of a backup process or a restore process using the volume snapshots 212. Each of the volume snapshots 212 includes a duplication of all the data held on a volume at one well-defined instant in time. In one exemplary implementation, various metadata is exchanged between the requestor 204, the writer 206 and the provider 208.

For example, the requester 204 controls volume snapshot features by setting various parameters that indicate whether volume snapshots 212 will survive the current operation and the degree of coordination with the writer 206 and the provider 208. As another example, the writer 206 provides information specifying files or volumes being managed through read-only metadata (e.g., Writer Metadata Document). The requester 204 interprets the metadata, selects files for volume snapshot creation, and stores these decisions in its own metadata (e.g., Backup Components Document). Then, the writer 208 pauses scheduled Input/Output (I/O) activity prior to creating the volume snapshots 212 and then, returns to normal operation following completion of volume snapshot creation.

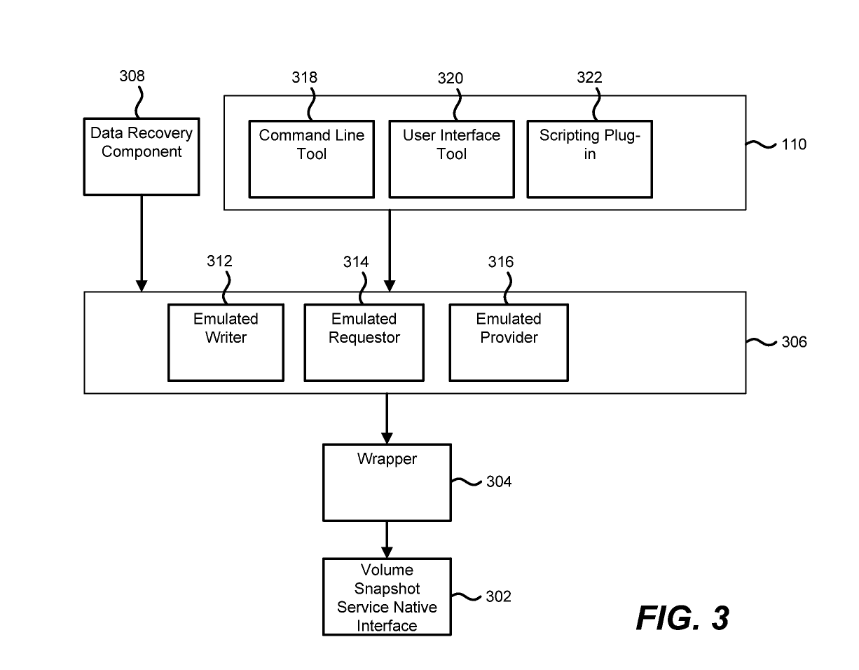

FIG. 3 is a block diagram illustrating an exemplary framework for verifying a data recovery component according to one example implementation. The exemplary framework includes various layers, such as a volume snapshot service native interface 302, a wrapper 304, a managed interface layer 306 for verifying a data recovery component 308, and an application layer 310.

As described herein, the volume snapshot service native interface 302 includes a group of interfaces (e.g., a mixture of C++ and Component Object Model (COM) interfaces) that allow volume backup processes and restore processes to be performed while applications on an operating system continue to write the files. The wrapper 304 enables communication and interoperability between the volume snapshot service native interface 302 and the managed interface layer 306 by implementing native operations in a higher level programming platform. An emulated writer 312, an emulated requestor 314 and an emulated provider 316 can be built on top of the managed interface layer 306. The wrapper 304 also provides the common utility functionalities that may be used by the data recovery component 308. Alternatively, the managed interface layer 306 may include a managed-code environment that interacts with the volume snapshot service native interface 302 via a COM Interoperability Assembly.

A command line tool 318 allows customers to input instructions for using the managed interface. For example, a customer may provide instructions for listing writers and writer components on a current system. In addition to the command line tool 318, a user interface (UI) tool 320 may be built on the managed interface layer 306 for the purpose of issuing step by step backup and restore instructions. In another exemplary implementation, the managed interface layer 306 permits the use of scripting to access the volume snapshot service native interface 302. For example, a scripting plug-in (e.g., a PowerShell cmdlet interface) may be built on the managed interface layer 306 and enable backup and restoration through an execution of a script.

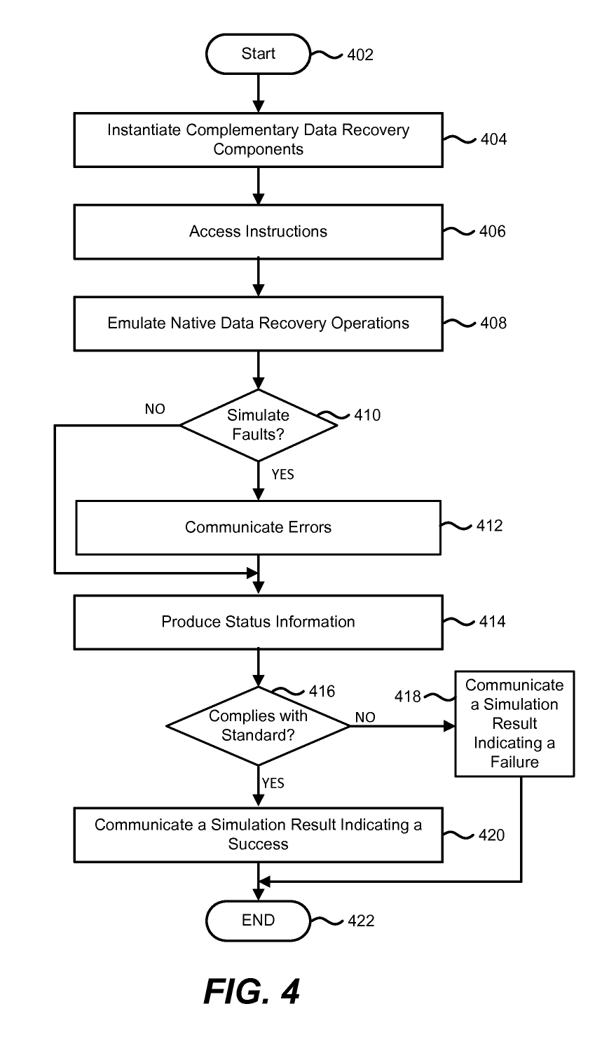

FIG. 4 is a flow diagram illustrating steps for verifying a data recovery component using a managed interface according to one example implementation. Steps depicted in FIG. 4 commence at step 402 and proceed to step 404 when the emulation module 102 instantiates one or more complementary data recovery components. In one exemplary implementation, the emulation module 102 implements volume snapshot service native interface functions using a higher-level programming platform. Such implementations form a managed interface from which the one or more complementary data recovery components are built. Hence, the one or more complementary data recovery components process instructions that are compatible with the higher-level programming platform. Furthermore, each of the native interface functions refers to one or more native data recovery operations in C++/COM interfaces according to one exemplary implementation.

Step 406 is directed to accessing instructions built in accordance with a higher level programming platform (e.g., .NET framework). In one exemplary implementation, the emulation module 102 uses a common language infrastructure (CLI), which ensures compatibility between various programming languages, to process the instructions. Step 408 is directed to emulating native data recovery operations in response to the instructions. After accessing the instructions, the emulation module 102 converts the instructions into the native data recovery operations using various mechanisms. As described herein, a custom set of interfaces (i.e., a wrapper) that implements the native interface functions may be used to ensure interoperability with the native interface.

Step 410 illustrates a decision as to whether to simulate faults during the emulation that is performed during step 408. In order to verify compatibility with the one or more data recovery components, the emulation module 102 communicates errors (e.g., error return codes) to the data recovery component being tested as represented by step 412. Based on a response, the emulation module 102 determines whether the data recovery component complies with standard protocol rules and behaviors.

In an alternate exemplary implementation, the data recovery component induces fault conditions by communicating erroneous instructions and/or violating the standard protocol rules and behaviors. The purpose of which is to test error handling and troubleshooting at the data recovery component. For example, the data recovery component may be a requestor that starts and stops a backup process before completion. The emulation module 102 returns appropriate errors and/or events that should not cause the data recovery component to crash. For example, the emulation module 102 communicates .NET versions of counterpart COM events using common language runtime (CLR).

Step 414 is directed to producing status information that describes behaviors of the data recovery component and responses by the one or more complementary data recovery components during the execution of the native data recovery operations. In one exemplary implementation, the status information includes codes or values that are returned by the one or more complementary data recovery components. These codes or values may indicate successful completion of a backup process or a restore process. On the other hand, these codes or values may indicate one or more errors that occurred during any of these processes.

Step 416 illustrates a determination as to whether the status information complies with a standard. As described herein, the standard refers to compliant behaviors and activities associated with the backup process and/or the restore process. For example, if a requestor instructed a hardware provider to prepare snapshot for a volume from an unsupported LUN, the hardware provider is to return an appropriate failure code. If the requestor did not call a function that determines whether the LUN is supported prior to preparing the volume snapshot, the requestor is not in compliance with the standard and therefore, is incompatible with the hardware provider.

On the other hand, if the hardware provider did not communicate accurate LUN information and the requestor communicated otherwise correct instructions, then the hardware provider did not comply with the standard and therefore, is incompatible with the requestor. In yet another exemplary implementation, if the requestor purposely induced such a fault and correctly handled the errors returned by the hardware provider, then both are in compliance with the standard. Hence, the hardware provider and the requestor are interoperable and compatible with each other.

If a comparison between the status information and the standard indicates non-compliance by the emulated native data recovery operations, step 418 is performed. Step 418 is directed to communicating a simulation result indicating a failure to the data recovery component. On the other hand, if the comparison indicates compliance, step 420 is performed where the simulation result is communicated indicating a success. Step 422 terminates the steps of the method illustrated by FIG. 4.

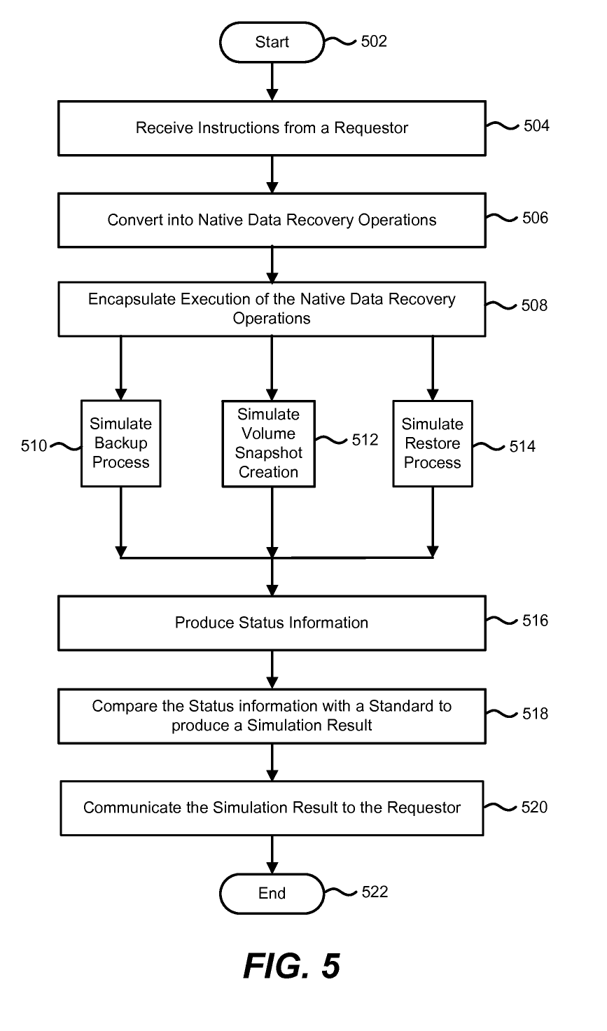

FIG. 5 is a flow diagram illustrating steps for verifying a requestor using a managed interface according to one example implementation. Steps depicted in FIG. 5 commence at step 502 and proceed to step 504 when the emulation module 102 receives instructions from a requestor. These instructions utilize functions on a managed interface that is built on a higher level programming platform (e.g., .NET) and enables interoperability with native interfaces (e.g., COM/C++) for volume snapshot services.

Step 506 illustrates conversion of the instructions into native data recovery operations that are in accordance with the native interfaces. As described herein, the managed interface uses functions associated with a custom wrapper (e.g., the wrapper 304 of FIG. 3) to effectuate the conversion according to one exemplary implementation. Step 508 represents encapsulating execution of the native data recovery operations. Via the native interfaces, the volume snapshot service responds to these operations by issuing events (e.g., identify, PrepareSnapshot, PreBackup and/or the like), calling functions and/or establishing parameters on writers and providers. The native data recovery operations may refer to creating a snapshot, performing a backup of one or more files to backup media and/or restoring the one or more files to a volume. Accordingly, after completing step 508, the method described in FIG. 5 may proceed to step 510, step 512 or step 514 during which the emulation module 102 simulates execution of any of these processes.

Step 510 refers to simulating a volume snapshot creation process in response to the native data recovery operations. In one exemplary implementation, the writers and the providers are emulated and implemented in the higher level programming platform by the emulation module 102. Accordingly, the requestor, via the managed interface and the volume snapshot service, requests metadata from the writers, selects one or more files or volumes and identifies an appropriate, emulated writer for the selected files or volumes. As a response, the identified writer prepares the volumes for snapshot creation, which includes determining which files are to be shadow copied, determining whether the writer will participate in a volume snapshot freeze, creating writer-specific metadata and/or the like.

The volume snapshot service, via the managed interface, requests metadata, such as Logical Unit Number (LUN) information, from the emulated providers and proceeds to map volumes to LUNs, determine which LUNS store the selected files or volumes and whether these LUNS are supported. Then, the volume snapshot service, on behalf of the requestor, selects an appropriate emulated provider to complete the volume snapshot creation process simulation. Furthermore, the volume snapshot service establishes various parameters (i.e., also known as context) for the provider, such as whether the volume snapshot is a copy-on-write and/or full copy mirror (e.g., differential). Once the emulation module 102 notifies the requestor that the simulated volume snapshot creation process completed, the requestor may initiate a backup process or a restore process at a later point-in-time.

In one exemplary implementation, the emulation module 102 simulates the backup process, as represented by step 512, on a snapshot that already exists on a LUN supported by the emulated provider. The requestor, via the managed interface, issues instructions for migrating point-in-time consistent application data to the backup media. These instructions are converted into native data recovery operations that indicate a type of backup, such as a full, incremental or differential backup as well as other parameters. The appropriate emulated writer, in turn, provides information associated with moving one or more files to backup media. In an alternate exemplary implementation, the emulation module 102, via the managed interface, simulates the restore process as represented by step 514. The appropriate emulated writer, as a response, provides information associated with moving one or more files to a target volume or produces an error to simulate a transient problem with the restore process.

Step 516 is directed to producing status information associated with the simulation of the volume snapshot creation process, the backup process or the restore process. For example, the emulation module 102 may process values returned by the emulated provider or the emulated writer. As another example, the emulation module 102 may request the status information from the emulated provider or the emulated writer. Step 518 is directed to comparing the status information with a standard to produce a simulation result. Step 520 is directed to communicating the simulation result to the requestor for further evaluation. Step 522 terminates the steps of the method illustrated by FIG. 5.

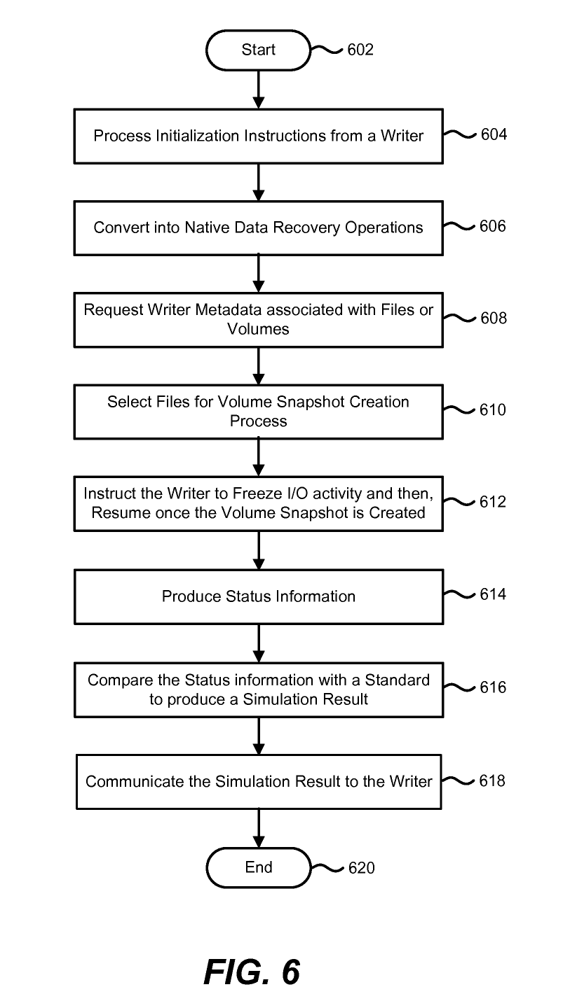

FIG. 6 is a flow diagram illustrating steps for verifying a writer using a managed interface according to one example implementation. Steps depicted in FIG. 6 commence at step 602 and proceed to step 604 when the emulation module 102 receives initialization instructions from a writer. Furthermore, these instructions utilize functions on a managed interface that is built on a higher level programming platform (e.g., .NET) and enables interoperability with native interfaces (e.g., COM/C++) for volume snapshot services.

Step 606 is directed to converting the initialization instructions into native data recovery operations that are compatible with the native interfaces. In one exemplary implementation, the writer, via the managed interface provided by the emulation module 102, creates an object that can be used by the volume snapshot service for communication and event handling purposes. Furthermore, the object includes various metadata, such as a writer id, an instance id and a type for data is managed by the writer, maximum timeout permitted between a freeze event and a thaw event and/or the like. As described herein, exceeding such a timeout causes the writer, via the managed interface, to issue an error event to a requestor. In response, the requestor issues an abort backup event, via the volume snapshot service, in order to inform all of the writers involved in a current backup or volume snapshot creation process.

Step 608 is directing to requesting writer metadata associated with actual files or volumes being managed. In one exemplary implementation, the writer returns file names and path information as well as file metadata (e.g., byte offsets). Based on this information, the requestor selects one or more volumes for volume snapshot creation as described in step 610. The volume snapshot service creates a snapshot set and instructs the writer to prepare for a snapshot.

Step 612 is directed to instructing the writer to freeze input/output activity and then, resume such activity once a thaw event is received indicating that the volume snapshot creation process completed. In one alternative exemplary implementation, the writer may participate in a subsequent backup of point-in-time consistent application data to backup media using the created snapshot. Furthermore, the creation of the snapshot and/or backup of the application data may be simulated or actually performed in order to verify the writer.

Step 614 is directed to producing status information associated with the volume snapshot creation process. For example, the emulation module 102 may process values returned by the emulated provider or the emulated requestor. As another example, the emulation module 102 may request the status information from the emulated provider or the emulated requestor. Step 616 is directed to comparing the status information with a standard to produce a simulation result. Step 618 is directed to communicating the simulation result to the writer for further evaluation. As described herein, the writer can receive an abort backup event from the emulated requestor, or the emulated provider can trigger one itself. In handling an abort backup event, the writer is to restore whatever input/output activity it executed to its normal running state as well as perform any error handling and logging. The emulation module 102 may include any logged errors and returned values from the writer in the status information. For example, the writer may run out of memory or any other resource to which the volume snapshot service waits and retries creating the volume snapshot. If the writer continues to run out of the memory, the simulation result may be used by the writer developer to identify any problems with memory usage. Step 620 terminates the steps of the method illustrated by FIG. 6.

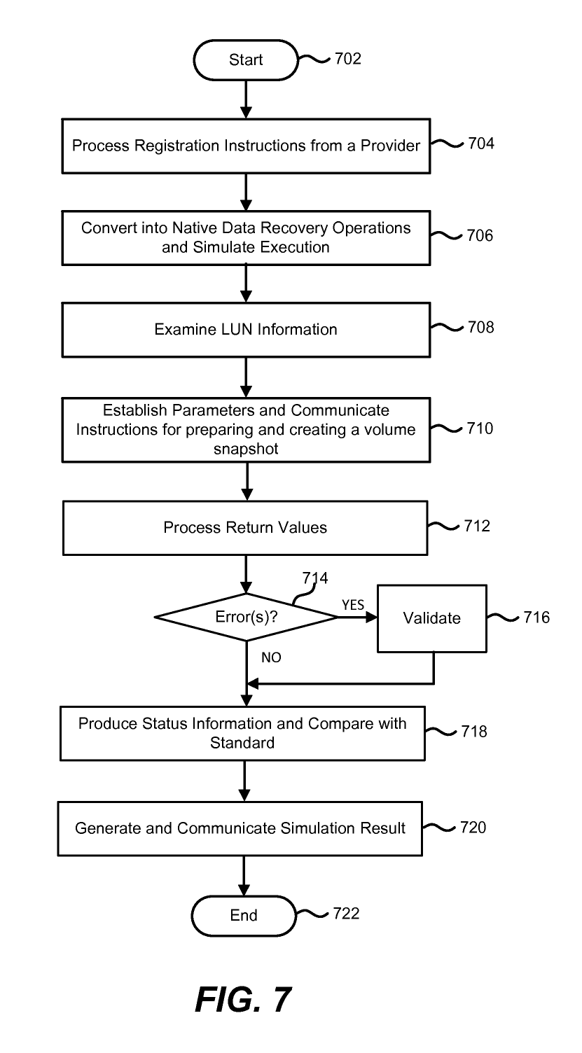

FIG. 7 is a flow diagram illustrating steps for verifying a provider using a managed interface according to one example implementation. Steps depicted in FIG. 7 commence at step 702 and proceed to step 704 when the emulation module 102 receives registration instructions from a provider. These instructions utilize functions on a managed interface that is built on a higher level programming platform (e.g., .NET) and enables interoperability with native interfaces (e.g., COM/C++) for volume snapshot services.

Step 706 is directed to converting the registration instructions into native data recovery operations and simulating execution of such operations. The volume snapshot service registers a provider id and a provider type and then, loads an instance of the provider. Step 708 is directed to examining LUN information that is communicated by the provider. The volume snapshot service, via the managed interface provided by the emulation module 102, uses the LUN information to identify which volumes are stored on which LUN or LUNs. Furthermore, the volume snapshot service uses the LUN information to discover LUNs created during the volume snapshot creation process and transport LUNs on a Storage Area Network (SAN).

Step 710 illustrates establishing parameters and communicating instructions for preparing and creating a volume snapshot. As described herein, such parameters (i.e., provider context enumerations) may specify that the volume snapshot is an auto-release, non-persistent copy created with or without writer participation. The parameters may also instruct the provider to use a rollback mechanism to ensure that the files or volumes are in well-defined state and point-in-time consistent. If one of the parameters is invalid or the restore method is in correct, the provider must return values (e.g., codes) indicating such errors.

Step 712 is directed to processing returned values from the provider. Step 714 represents a decision as to whether the returned values indicate one or more errors. If the returned values include one or more error codes, step 716 is performed during which the one or more errors are validated. For example, if the emulated requestor purposefully utilized an invalid parameter when preparing a volume for snapshot creation, then the provider responded appropriately by returning a corresponding error code.

Regardless of whether the returned values do or do not include any error codes, step 718 is performed where status information is produced and compared with a standard. Step 720 represents generating and communicating a simulation result based on the comparison performed at step 718. In one exemplary implementation, the simulation result indicates whether the provider complied with required provider behavior. As an example, there are multiple timing limit windows that providers must follow. Well-behaved providers will perform all unnecessary processing before committing a volume snapshot and after committing the volume snapshot. Step 722 terminates the steps of the method illustrated by FIG. 7.

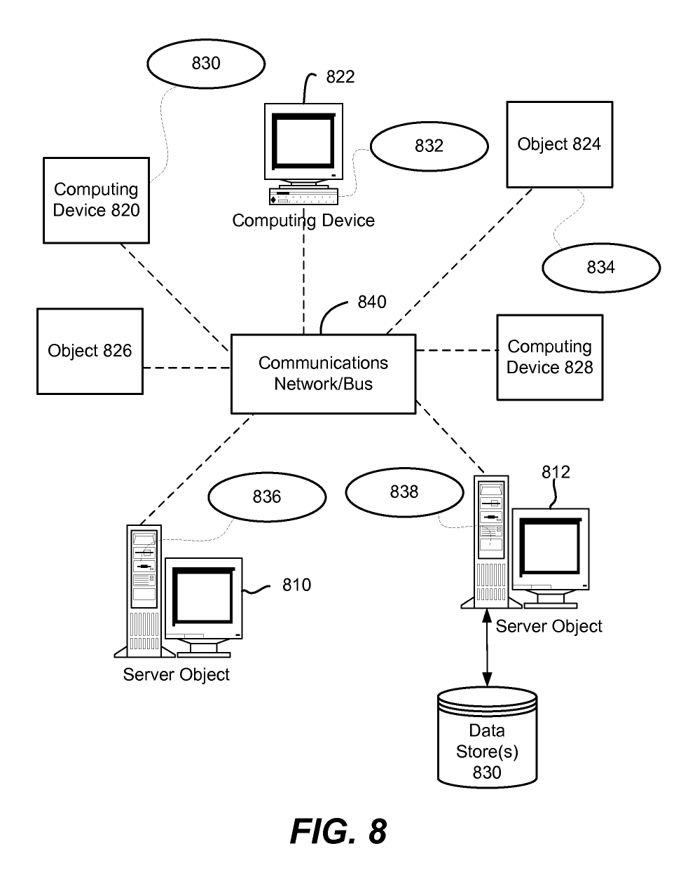

FIG. 8 provides a schematic diagram of an exemplary networked or distributed computing environment. The distributed computing environment comprises computing objects 810, 812, etc., and computing objects or devices 820, 822, 824, 826, 828, etc., which may include programs, methods, data stores, programmable logic, etc. as represented by example applications 830, 832, 834, 836, 838. It can be appreciated that computing objects 810, 812, etc. and computing objects or devices 820, 822, 824, 826, 828, etc. may comprise different devices, such as personal digital assistants (PDAs), audio/video devices, mobile phones, MP3 players, personal computers, laptops, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, communications network 840 may comprise other computing objects and computing devices that provide services to the system of FIG. 8, and/or may represent multiple interconnected networks, which are not shown. Each computing object 810, 812, etc. or computing object or device 820, 822, 824, 826, 828, etc. can also contain an application, such as applications 830, 832, 834, 836, 838, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc., acting as servers provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 840 or bus is the Internet, for example, the computing objects 810, 812, etc. can be Web servers with which other computing objects or devices 820, 822, 824, 826, 828, etc. communicate via any of a number of known protocols, such as the hypertext transfer protocol (HTTP). Computing objects 810, 812, etc. acting as servers may also serve as clients, e.g., computing objects or devices 820, 822, 824, 826, 828, etc., as may be characteristic of a distributed computing environment.

### Exemplary Computing Device

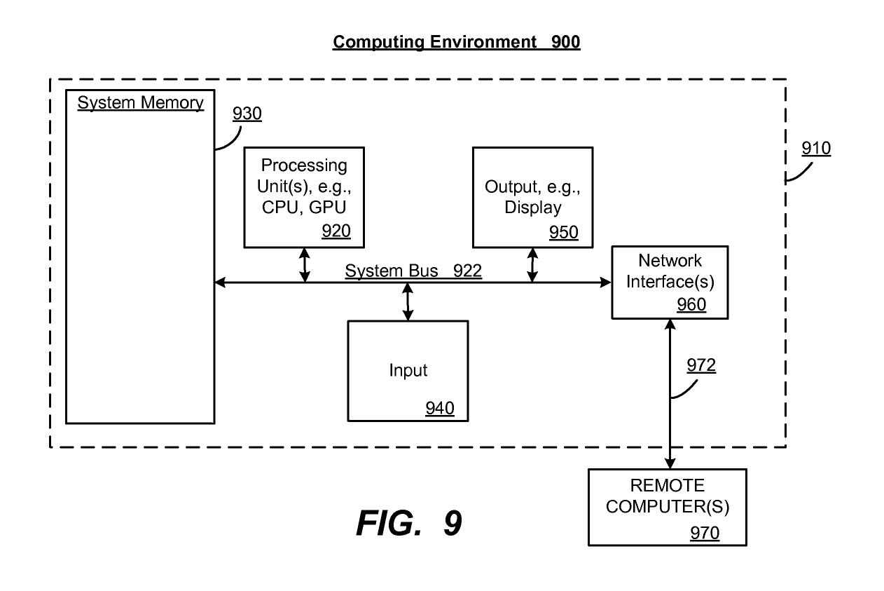

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 9 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 9 thus illustrates an example of a suitable computing system environment 900 in which one or aspects of the embodiments described herein can be implemented, although as made clear above, the computing system environment 900 is only one example of a suitable computing environment and is not intended to suggest any limitation as to scope of use or functionality. In addition, the computing system environment 900 is not intended to be interpreted as having any dependency relating to any one or combination of components illustrated in the exemplary computing system environment 900.

With reference to FIG. 9, an exemplary remote device for implementing one or more embodiments includes a general purpose computing device in the form of a computer 910. Components of computer 910 may include, but are not limited to, a processing unit 920, a system memory 930, and a system bus 922 that couples various system components including the system memory to the processing unit 920.

Computer 910 typically includes a variety of computer readable media and can be any available media that can be accessed by computer 910. The system memory 930 may include computer storage media in the form of volatile and/or nonvolatile memory such as read only memory (ROM) and/or random access memory (RAM). By way of example, and not limitation, system memory 930 may also include an operating system, application programs, other program modules, and program data.

A user can enter commands and information into the computer 910 through input devices 940. A monitor or other type of display device is also connected to the system bus 922 via an interface, such as output interface 950. In addition to a monitor, computers can also include other peripheral output devices such as speakers and a printer, which may be connected through output interface 950.

The computer 910 may operate in a networked or distributed environment using logical connections to one or more other remote computers, such as remote computer 980. The remote computer 980 may be a personal computer, a server, a router, a network PC, a peer device or other common network node, or any other remote media consumption or transmission device, and may include any or all of the elements described above relative to the computer 910. The logical connections depicted in FIG. 9 include a network 982, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between one or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, providing a managed interface for verifying a data recovery component, including, accessing instructions for using a complementary data recovery component, wherein the complementary data recovery component is interoperable with the data recovery component via the managed interface, emulating native data recovery operations in response to the instructions and producing status information associated with the native data recovery operations.

2. The method of claim 1, wherein emulating the native data recovery operations further comprises identifying at least one error in response to the native data recovery operations.

3. The method of claim 1, wherein emulating the native data recovery operations further comprises generating metadata associated with using the complementary data recovery component.

4. The method of claim 1, wherein emulating the native data recovery operations further comprises simulating a backup process or a restore process.

5. The method of claim 1, wherein emulating the native data recovery operations in response to the instructions further comprises simulating a volume snapshot creation process.

6. The method of claim 1 further comprising validating at least one error that is returned by the data recovery component.

7. The method of claim 1, wherein emulating the native data recovery operations further comprises establishing at least one parameter for creating at least one volume snapshot.

8. The method of claim 1, wherein emulating the native data recovery operations further comprises converting the instructions into at least one of the native data recovery operations that correspond with the data recovery component.

9. The method of claim 1, wherein accessing the instructions for using at least one complementary data recovery component further comprises executing a script that generates the instructions for performing a backup process or a restore process.

10. The method of claim 1 further comprising comparing the status information with a standard associated with a volume snapshot creation process, a backup process or a restore process to produce a simulation result, wherein the simulation result is communicated to the data recovery component.

11. In a computing environment, a system, comprising, an emulation module for verifying a data recovery component using a managed interface, wherein the managed interface is configured to permit interoperability between the data recovery component and a complementary data recovery component, wherein the emulation module is further configured to convert instructions from the data recovery component into native data recovery operations for using the complementary data recovery component, executing the native data recovery operations and communicate a simulation result associated with the native data recovery operations to the data recovery component.

12. The system of claim 11, wherein the instructions are produced from a script.

13. The system of claim 11, wherein the emulation module validate at least one error returned by the data recovery component in response to the native data recovery operations.

14. The system of claim 11, wherein the emulation module compares status information from the complementary data recovery component with a standard to produce a simulation result.

15. The system of claim 11, wherein the emulation module generates metadata while executing of the native data recovery operations.

16. The system of claim 11, wherein the emulation module simulates a backup process or a restore process.

17. One or more computer-readable media having computer-executable instructions, which when executed perform steps, comprising:
access instructions for using a complementary data recovery component to process at least one volume snapshot, wherein the complementary data recovery component are interoperable with a data recovery component via managed interface;
emulating native data recovery operations in response to the instructions;
producing status information associated with the native data recovery operations; and
verifying the data recovery component based on the status information.

18. The one or more computer-readable media of claim 17 having further computer-executable instructions comprising:
validating at least one error returned by the data recovery component in response to the native data recovery operations.

19. The one or more computer-readable media of claim 17 having further computer-executable instructions comprising:
converting the instructions into at least one of the native data recovery operations that correspond with the data recovery component.

20. The one or more computer-readable media of claim 17 having further computer-executable instructions comprising:
comparing the status information with a standard associated with a volume snapshot creation process, a backup process or a restore process to produce a simulation result; and
communicating the simulation result to the data recovery component.
